(19) United States
(12) Patent Application Publication
(10) Pub. No.: US 2026/0005763 A1
(43) Pub. Date: Jan. 1, 2026

(54) CALCULATION DEVICE, NETWORK DEVICE, CALCULATION METHOD AND PROGRAM

(71) Applicant: Nippon Telegraph and Telephone Corporation, Tokyo (JP)

(72) Inventors: Kenta Hirose, Musashino-shi, Tokyo (JP); Takafumi FUKATANI, Musashino-shi, Tokyo (JP); Masahiro NAKAGAWA, Musashino-shi, Tokyo (JP); Takeshi SEKI, Musashino-shi, Tokyo (JP); Takashi MIYAMURA, Musashino-shi, Tokyo (JP)

(21) Appl. No.: 18/880,366

(22) PCT Filed: Jul. 11, 2022
(86) PCT No.: PCT/JP2022/027329

§ 371 Date: Dec. 31, 2024

(51) Int. Cl. H04B 10/079; H04B 10/25

(52) U.S. Cl. CPC H04B 10/07955; H04B 10/25

(57) ABSTRACT

A calculation apparatus (30) calculates an input power to an optical fiber transmission path of each channel in two adjacent bands. The calculation apparatus (30) assumes that a transition of a span incoming power due to an influence of stimulated Raman scattering depends on the number of existing channels in an optical fiber transmission path, and calculates an input power for eliminating a slope of the span incoming power using a coefficient r indicating a power ratio of a target channel and an adjacent channel.

### TECHNICAL FIELD

The present invention relates to a calculation apparatus, a network apparatus, a calculation method, and a program.

### BACKGROUND ART

As one optical fiber nonlinear optical effect generated in wavelength multiplex transmission, a power transition between channels (wavelengths) due to stimulated Raman scattering (SRS) is known (see, for example, NPL 1 to NPL 4). FIG. 15A is a conceptual diagram of a power transition between channels. A first horizontal axis indicates a frequency and a second horizontal axis indicates a wavelength. Here, it is assumed that input powers of respective channels are equal. A channel value (channel i) is small on the right side and large on the left side in the horizontal axis. A channel adjacent to a high frequency short wavelength side (right side) viewed from the channel i is a channel i−1. A channel adjacent to a low frequency long wavelength side (left) as viewed from the channel i is a channel i+1. A value of the wavelength corresponding to the channel is small on the right side and large on the left side of the horizontal axis (λᵢ₌₁>λᵢ>λᵢ₋₁). On the other hand, a value of the frequency is great on the right side and small on the left side of the horizontal axis (fᵢ₊₁<fᵢ<fᵢ₋₁).

The optical signal of each channel is transmitted through the optical fiber over a predetermined span length. In this case, a power Pᵢ₋₁ or the like of the channel adjacent to the higher frequency shorter wavelength side (right) as compared to the channel i transitions to the power Pᵢ side of the channel i due to SRS. Further, the power Pᵢ of the channel i transitions to the power Pᵢ₊₁ of the channel adjacent to the low frequency long wavelength side (left).

Therefore, the post-transmission power of each channel varies in signal quality depending on the wavelength. For example, as illustrated in FIG. 15B, the power Pᵢ₋₁ or the like after transmission of a channel adjacent to a higher frequency short wavelength side (right) than a channel i increases in loss as the frequency becomes higher. Further, a post-transmission power Pᵢ₊₁ or the like of the channel adjacent to the lower frequency long wavelength side (left) than the channel i has a smaller loss at a lower frequency. Therefore, a right downward slope (tilt) is generated in a spectrum of the post-transmission power of each channel, as indicated by a two-dot chain line in FIG. 15B.

### CITATION LIST

### Non Patent Literature

[NPL 1] Kenta Hirose, Takafumi Fukatani, Masahiro Nakagawa, Takeshi Seki, Takashi Miyamura, “Analysis of Stimulated-Raman-Scattering Effect Changed by the Number of Optical Channels on Multiband Wavelength-Division-Multiplexed Networks,” IEICE Technical Report, vol. 121, No. 386, PN2021-57, pp. 29-32, March 2022.
[NPL 2] DANIEL SEMRAU, ROBERT KILLEY, POLINA BAYVEL, “Achievable rate degradation of ultra-wideband coherent fiber communication systems due to stimulated Raman scattering,” Optics Express, vol. 25, No. 12, 13024-13034, June 2017.
[NPL 3] Hiroki Kawahara, Kohei Saito, Sachio Suda, Takeshi Seki, and Hideki Maeda, “Cancellation of Static and Dynamic Power Transitions induced by inter-band Stimulated Raman Scattering in C+L band WDM Transmission,” 25th OptoElectronics and Communications Conference, Taipei, Taiwan, October 2020.
[NPL 4] Fukutaro Hamaoka, Kyo Minoguchi, Takeo Sasai, Asuka Matsushita, Masanori Nakamura, Seiji Okamoto, Etsushi Yamazaki, and Yoshiaki Kisaka, “150.3-Tb/s Ultra-Wideband (S, C, and L Bands) Single-Mode Fibre Transmission over 40-km Using >519 Gb/s/λ PDM-128QAM Signals,” 44th European Conference on Optical Communication, Rome, Italy, September 2018.

### SUMMARY OF INVENTION

### Technical Problem

In a dense wavelength division multiplexing (DWDM) technology of the related art using single-band, that is, a wavelength band of a C band (Conventional) or an L band (Long wavelength), an influence of a power transition between channels can be said to neglectable. (wavelength, frequency) of the C band is (1530-1565 nm, 191.56-195.94 THz). (wavelength, frequency) of the L band is (1565-1625 nm, 184.49-191.56 THz). Therefore, the wavelength band of the C band or L band is about a 4.8 THz band.

On the other hand, when DWDM using multi-bands such as the C+L band (about 10 THz in width) is assumed, an influence of a power transition between channels becomes apparent, leading to problems such as a variation in signal quality due to wavelength. For example, when the power in the C band moves to the L band side during optical propagation, an excessive loss will occur in the C band, and a signal power will drop too much at a point that the light reaches. Therefore, in the related art, a technology for increasing input power of light in a short wavelength band where a power transition occurs, and making received power constant from the short wavelength band to a long wavelength band on the receiving side (output side) has been proposed. However, in the related art, it is necessary to take measures such as, for example, investigating a rate of change in received power through an experiment and adjusting input power (transmission power) for each wavelength on the basis of a value thereof.

Therefore, an object of the present invention is to provide a calculation apparatus, a network apparatus, a calculation method, and a program capable of solving the above problems and calculating input power for eliminating a slope of span incoming power in DWDM.

### Solution to Problem

A calculation apparatus according to the present invention is a calculation apparatus for calculating input power to an optical fiber transmission path of each channel in two adjacent bands, wherein the calculation apparatus assumes that a transition of span incoming power due to an influence of stimulated Raman scattering depends on the number of existing channels in an optical fiber transmission path, and calculates input power for eliminating a slope of the span incoming power using a coefficient r indicating a power ratio of a target channel and an adjacent channel.

### Advantageous Effects of Invention

According to the present invention, it is possible to calculate the input power for eliminating the slope of the span incoming power in DWDM

### BRIEF DESCRIPTION OF DRAWINGS

FIG. 1 is a schematic configuration diagram of a system including a calculation apparatus and a network apparatus according to a first embodiment of the present invention.

FIG. 2A is a schematic diagram of a wavelength multiplexing network.

FIG. 2B is a schematic diagram of a power spectrum.

FIG. 3A is a flowchart illustrating a flow of processing of the calculation apparatus according to the first embodiment.

FIG. 3B is a flowchart illustrating a flow of processing of the calculation apparatus according to a second embodiment.

FIG. 4A is a graph showing a loss coefficient in a single mode optical fiber.

FIG. 4B is a graph showing a Raman gain coefficient in the single mode optical fiber.

FIG. 4C is a graph showing a part of FIG. 4B.

FIG. 4D is a graph obtained by linear approximation of the Raman gain coefficient in FIG. 4C.

FIG. 5 is an example of a relational equation between a coefficient r and a power P1(0).

FIG. 6A is a graph showing Example 1.

FIG. 6B is a graph showing an enlarged version of

FIG. 6A.

FIG. 6C is a graph showing a comparative example.

FIG. 6D is a graph showing Example 2.

FIG. 6E is a graph showing Example 3.

FIG. 7A is a schematic diagram of a wavelength multiplexing network.

FIG. 7B is an example of a power spectrum before merging.

FIG. 7C is another example of the power spectrum before merging.

FIG. 7D is an example of a power spectrum after merging.

FIG. 8A is a schematic diagram of a set (a first set) in which a difference due to wavelength disposition is maximized.

FIG. 8A is a schematic diagram of a set (a second set) in which a difference due to wavelength disposition is maximized.

FIG. 8C is a schematic diagram of a set (a third set) in which a difference due to wavelength disposition is maximized.

FIG. 8D is a schematic diagram of a set (a fourth set) in which a difference due to wavelength disposition is maximized.

FIG. 9A is a graph showing Example 4.

FIG. 9B is a graph showing Example 5.

FIG. 9C is a graph showing Example 6.

FIG. 9D is a graph showing Example 7.

FIG. 10A is a graph showing Example 8.

FIG. 10B is a graph showing Example 9.

FIG. 10C is a graph showing Example 10.

FIG. 11A is a graph showing Example 11.

FIG. 11B is a graph showing Example 12.

FIG. 11C is a graph showing Example 13.

FIG. 12A is a graph showing Example 14.

FIG. 12B is a graph showing Example 15.

FIG. 12C is a graph showing Example 16.

FIG. 13A is a graph showing Example 17.

FIG. 13B is a graph showing Example 18.

FIG. 13C is a graph showing Example 19.

FIG. 14 is a hardware configuration diagram illustrating an example of a computer that realizes functions of the calculation apparatus according to the present embodiment.

FIG. 15A is a conceptual diagram of a power transition between channels.

FIG. 15B is a conceptual diagram of a slope of a power spectrum.

### DESCRIPTION OF EMBODIMENTS

Hereinafter, a calculation apparatus according to the present embodiment will be described in detail with reference to the drawings.

### [Overview of System Configuration]

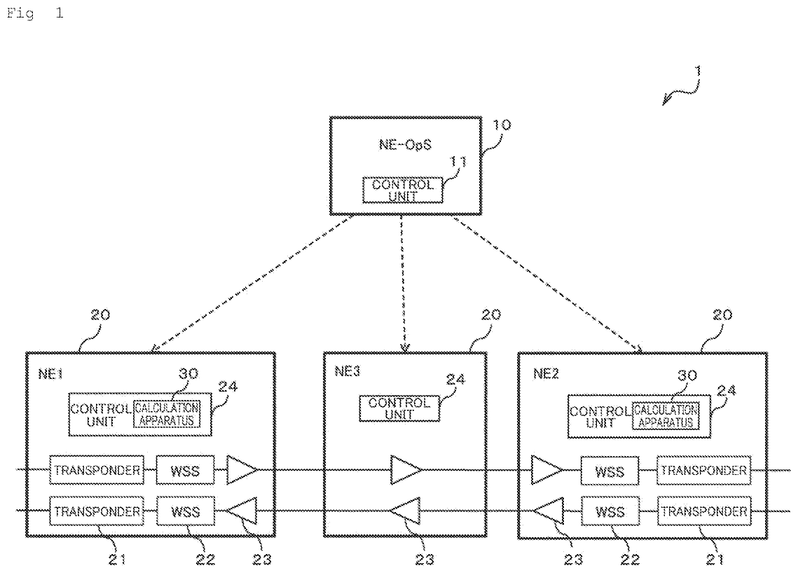

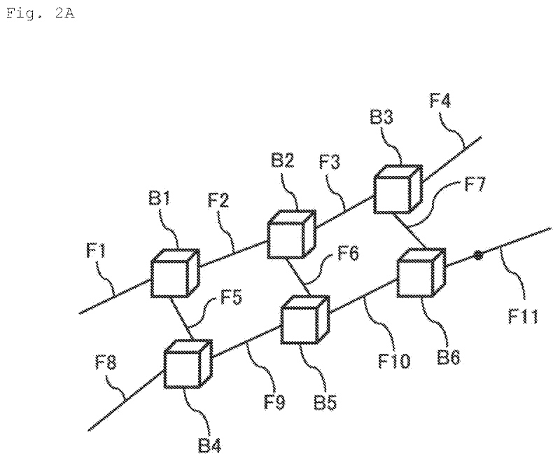

As illustrated in FIG. 1, an optical transmission system 1 includes a network equipment monitoring apparatus 10 and a network apparatus 20.

The network equipment monitoring apparatus 10 is configured by, for example, a network element operation system (NE-OpS). The network equipment monitoring apparatus 10 includes a control unit 11 that monitors the network apparatus 20.

The network apparatus 20 is, for example, an optical transmission apparatus such as a Reconfigurable Optical Add/Drop Multiplexer (ROADM). The network apparatus 20 includes, for example, a transponder 21, a wavelength selective switch (WSS) 22, an optical amplification unit 23, and a control unit 24. The number of network apparatuses 20 is arbitrary. When three network apparatuses illustrated in FIG. 1 are distinguished, the network apparatuses are written as NE1, NE2, and NE3, and when the network apparatuses are not distinguished, the network apparatuses are written as the network apparatus 20.

For example, when an electrical signal from an external communication apparatus is input to the transponder 21 of the network apparatus NE1, this electrical signal is converted into an optical signal by the transponder 21, multiplexed by the wavelength selective switch 22, amplified by the optical amplification unit 23, and then transmitted to the outside.

This optical signal is amplified, for example, by the optical amplification unit 23 of the network apparatus NE3. This amplified optical signal is, for example, amplified by the optical amplification unit 23 of the network apparatus NE2, demultiplexed by the wavelength selective switch 22, received by the transponder 21, and transmitted to a communication apparatus (not shown). This optical transmission system 1 performs bidirectional communication. Further, the network apparatus NE3 is an apparatus specialized in amplification of optical signals.

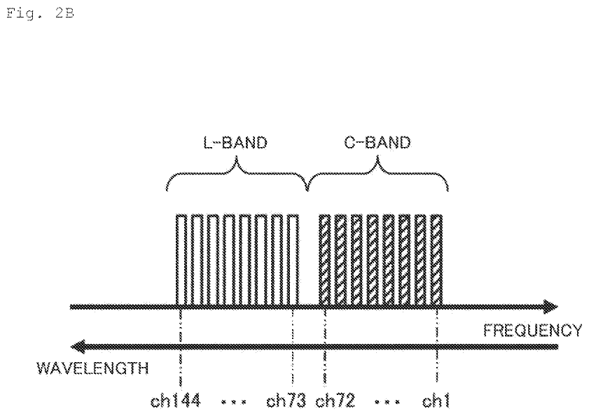

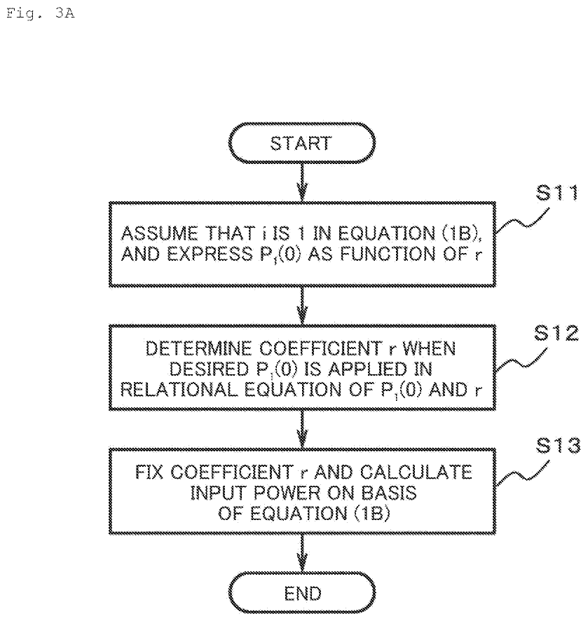

As illustrated in FIG. 2A, optical fiber transmission paths F1 to F11 are laid between a plurality of buildings B1 to B6 so that a wavelength multiplexing network is formed. At least one network apparatus 20 is disposed in each of the buildings B1 to B6.

The network apparatus 20 includes a calculation apparatus 30. Here, the control units 24 of NE1 and NE2, which are optical transmission apparatuses such as ROADMs, include the calculation apparatus 30 (see FIG. 1).

The calculation apparatus 30 calculates an input power to the optical fiber transmission path of each channel in two adjacent bands. The calculation apparatus 30 assumes that a span incoming power transition due to an influence of stimulated Raman scattering depends on the number of existing channels in the optical fiber transmission path, and calculates the input power for eliminating the slope of the span incoming power by using a coefficient r indicating the power ratio of the target channel and the adjacent channel.

The calculation apparatus 30 executes calculation of the input power of each channel on the basis of Equation (1) below. Here, i indicates a number indicating the channel (1≤i≤M). fᵢ indicates a center frequency of channel i (f_{M}≤fᵢ≤f₁ and 4 THz≤f₁−f_{M}≤15 THz). f indicates a center frequency interval of adjacent channels. Pᵢ(0) indicates input power (0.1 mW≤Pᵢ(0)≤10 mW) to the optical fiber transmission path of channel i. r indicates a coefficient for controlling Pᵢ(0) [dBm]. ρ₁ indicates a channel occupancy rate of a high frequency short wavelength side band 1. ρ₂ indicates the channel occupancy rate of a low frequency long wavelength side band 2. L indicates a span length of the optical fiber transmission path. α indicates a loss coefficient of the optical fiber transmission path. k indicates a slope of the Raman gain coefficient.

$$\begin{matrix}[ Math . 1 ] & \\ {P}_{i} ( 0 ) = \frac{2 α ( r - 1 ) ln r}{kf ( 1 - {e}^{- α L} ) ( {ρ}_{1} + {ρ}_{2} {r}^{\frac{M}{2}} ) ( 1 - {r}^{\frac{M}{2}} )} {r}^{\frac{{f}_{1} - {f}_{l}}{f}} & Equation ( 1 )\end{matrix}$$

### First Embodiment

The calculation apparatus 30 according to the first embodiment calculates the input power in a state in which all wavelengths are included in each band, as illustrated in FIG. 2B. As an example, two adjacent bands are the L band and the C band, and M is 144. In the C band, channel 1 (ch1) to channel 72 (ch72) are set in the C band, to correspond to 72 wavelengths. In the L band, channels 73 (ch1) to channel 144 (ch144) are set to correspond to 72 wavelengths. Hereinafter, such two bands will be expressed as L 72 ch and C 72 ch.

In this example, since the high frequency short wavelength side band 1 is the C band, ρ₁ is written as ρ_{C}. Further, since the low frequency long wavelength side band 2 is the L band, ρ₂ is written as ρ_{L}. The channel occupancy rate of ρ_{C} is 72/72=1 (100%). The channel occupancy rate of ρ_{L} is 72/72=1 (100%). That is, the calculation apparatus 30 of the present embodiment calculates the input power assuming that ρ₁=ρ₂=1 in Equation (1). In this case, Equation (1) can be rewritten as Equation (1B) below.

$$\begin{matrix}[ Math . 2 ] & \\ {P}_{i} ( 0 ) = \frac{2 α ( r - 1 ) ln r}{kf ( 1 - {e}^{- α L} ) ( 1 - {r}^{M} )} {r}^{\frac{{f}_{1} - {f}_{l}}{f}} & Equation ( 1 B )\end{matrix}$$

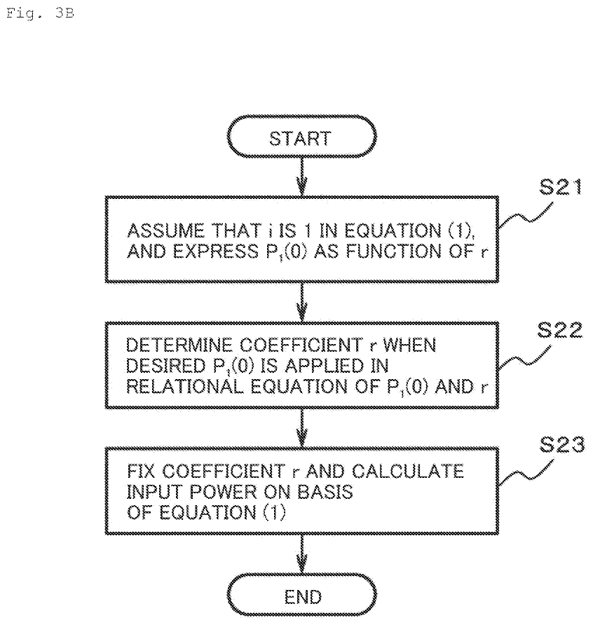

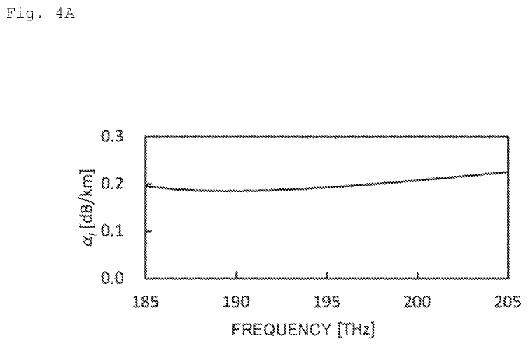

The calculation apparatus 30 according to the first embodiment determines the coefficient r when a desired communication possibility P₁(0) is applied in a case in which i is 1 in Equation (1B), and fixes the determined coefficient r to execute the calculation of the input power of each channel on the basis of Equation (1B). Specifically, the calculation apparatus 30 first expresses P₁(0) as a function of r assuming that i is 1 in Equation (1B), as illustrated in FIG. 3A (step S11). In this case, Equation (1B) can be rewritten as Equation (1C) below.

$$\begin{matrix}[ Math . 3 ] & \\ {P}_{1} ( 0 ) = \frac{2 α ( r - 1 ) ln r}{kf ( 1 - {e}^{- α L} ) ( 1 - {r}^{M} )} & Equation ( 1 C )\end{matrix}$$

The calculation apparatus 30 determines the coefficient r when the desired P₁(0) is applied in a relational equation (Equation (1C)) between P₁(0) and r (step S12). The calculation apparatus 30 fixes the coefficient r to calculate the input power on the basis of Equation (1B) (step 313).

Here, a derivation of Equation (1) will be briefly described using a mathematical equation.

It is known that the power change for each channel taking an inter-wavelength power transition due to stimulated Raman scattering into account is expressed by Equation (2) below (see NPL 2).

$$\begin{matrix}[ Math . 4 ] & \\ \frac{\partial {P}_{i}}{\partial z} = {\sum }_{j = 1}^{i - 1} \frac{1}{2} {g}_{R} ( Ω ) {P}_{j} {P}_{i} - {\sum }_{j = i + 1}^{M} \frac{{ω}_{j}}{2 {ω}_{i}} {g}_{R} ( Ω ) {P}_{j} {P}_{i} - {α}_{i} {P}_{i} & Equation ( 2 )\end{matrix}$$

In Equation (2), M indicates the total number of channels (total number of wavelengths), and i indicates a number indicating the channel (i=1 is the shortest wavelength). Pᵢ indicates the power of channel i, and ωᵢ indicates an angular frequency of channel i. z indicates a distance in a longitudinal direction of the optical fiber, and g_{R} (Ω) indicates the Raman gain coefficient. αᵢ indicates a loss coefficient at the frequency of channel i. Ω indicates a difference between the frequency of channel i and the frequency of channel j (hereinafter referred to as a frequency difference). First and second terms on the right side of Equation (2) indicate the inter-wavelength power transition due to stimulated Raman scattering. A third term indicates a transmission loss of the optical fiber.

The following several assumptions are used to derive Equation (1). Assumption 1 is that most of the inter-wavelength power transition due to the stimulated Raman scattering occur between effective lengths. Assumption 2 assumes that the following Equations (3a), (3b), (3c), and (3d) indicating approximations are established.

$${g}_{R} = k Ω \qquad Equation ( 3 a )$$

$${ω}_{j} / {ω}_{i} ? 1 \qquad Equation ( 3 b )$$

$${α}_{1} = α \qquad Equation ( 3 c )$$

$${L}_{eff , i} = {L}_{eff} \qquad Equation ( 3 d )$$

Equation (3a) shows that the Raman gain coefficient is linear with respect to the frequency difference. k indicates the slope of the Raman gain coefficient. Equation (3b) shows that the angular frequency is substantially constant regardless of the channel. Equation (3c) shows that the loss coefficient is constant regardless of a frequency of the channel. Equation (3d) shows that an effective length is constant regardless of the channel.

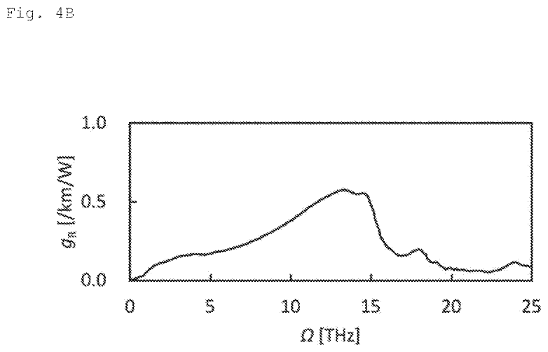

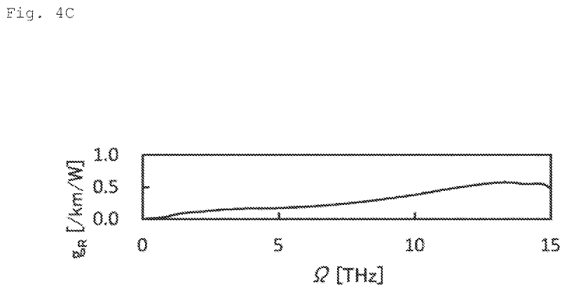

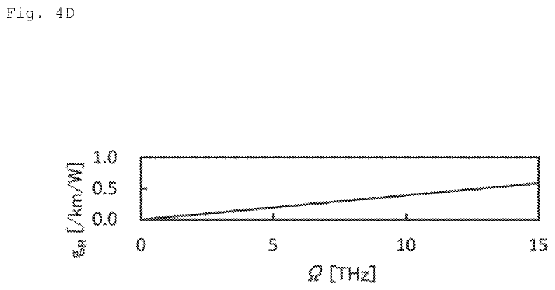

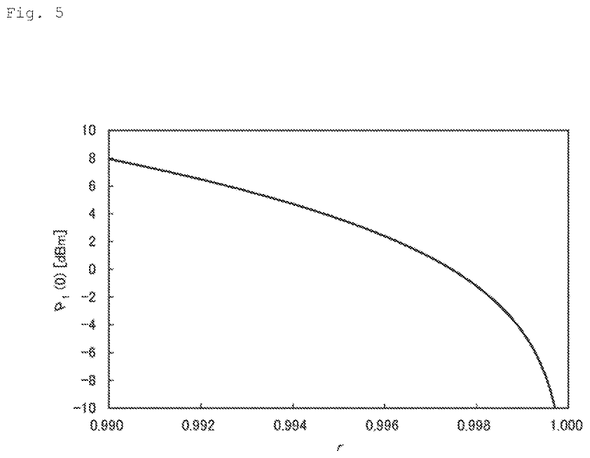

FIG. 4A illustrates an example of a loss coefficient αᵢ in a single mode optical fiber. A horizontal axis indicates a frequency ranges of the L band, the C band, and an S band (Short wavelength). FIG. 4B illustrates an example of the Raman gain coefficient in the single mode optical fiber. A horizontal axis indicates the frequency difference. When a frequency range obtained by combining two adjacent bands (about 10 THz width) is considered, a frequency difference is about 10 THz at most, and thus, an about left half of the graph in FIG. 4B may be considered. FIG. 4C is a graph showing a portion of FIG. 4B. FIG. 4D illustrates a Raman gain coefficient linearly approximated to the frequency difference, and corresponds to Equation (3a).

Further, Assumption 3 is that the inter-wavelength power transition due to stimulated Raman scattering does not depend on wavelength disposition in each band.

From Equation (2), Equation (3a), Equation (3b), Equation (3c), and Equation (3d), a spectrum at an effective length L_{eff} can be formulated as the following set of Equation (4a) and Equation (4b). When a channel occupancy rate ρⱼ in Equation (4b) is set to 1, the spectrum at the effective length Lett can be formulated as the following set of Equations (4a) and (4c).

$$\begin{matrix}[ Math . 5 ] & \\ ln \frac{{P}_{i} ( {L}_{eff} )}{{P}_{i} ( 0 )} = - {α}_{0 , i} \frac{1 - {e}^{- α L}}{α} & Equation ( 4 a )\end{matrix}$$

$$- {α}_{0 , i} = {\sum }_{j = 1}^{i - 1} \frac{1}{2} {g}_{R} ( Ω ) {ρ}_{j} {P}_{j} ( 0 ) - {\sum }_{j = i + 1}^{M} \frac{{ω}_{j}}{2 {ω}_{i}} {g}_{R} ( Ω ) {ρ}_{j} {P}_{j} ( 0 ) - {α}_{i} \qquad Equation ( 4 b )$$

$$- {α}_{0 , i} = {\sum }_{j = 1}^{i - 1} \frac{1}{2} {g}_{R} ( Ω ) {P}_{j} ( 0 ) - {\sum }_{j = i + 1}^{M} \frac{{ω}_{j}}{2 {ω}_{i}} {g}_{R} ( Ω ) {P}_{j} ( 0 ) - α \qquad Equation ( 4 c )$$

A recurrence equation for flattening the spectrum at the effective length L_{eff} between channel i and channel i+1 according to Equation (4a) is expressed by Equation (5a) below using a relationship of Equation (4b), and is expressed by Equation (5b) below when further arranged.

$$\begin{matrix}[ Math . 6 ] & \\ \begin{matrix}0 = ln {P}_{i} ( 0 ) - ln {P}_{i + 1} ( 0 ) - ( {α}_{0 , i} - {α}_{0 , i + 1} ) \frac{1 - {e}^{- α L}}{α} \\ = ln {P}_{i} ( 0 ) - ln {P}_{i + 1} ( 0 ) - \frac{k}{2} ( {f}_{i} - {f}_{i + 1} ) {\sum }_{j = 1}^{M} {ρ}_{j} {P}_{j} ( 0 ) \frac{1 - {e}^{- α L}}{α}\end{matrix} & Equation ( 5 a )\end{matrix}$$

$$ln \frac{{P}_{i + 1} ( 0 )}{{P}_{i} ( 0 )} = - \frac{kf}{2} {\sum }_{j = 1}^{M} {ρ}_{j} {P}_{j} ( 0 ) \frac{1 - {e}^{- α L}}{α} \qquad Equation ( 5 b )$$

When the channel occupancy rate ρⱼ is 1, the recurrence equation for flattening the spectrum at the effective length L_{eff} between channel i and channel i+1 according to Equation (4a) is expressed by Equation (5c) below using a relationship of Equation (4c), and is expressed by Equation (5d) below when further arranged.

$$\begin{matrix}[ Math . 7 ] & \\ \begin{matrix}0 = ln {P}_{i} ( 0 ) - ln {P}_{i + 1} ( 0 ) - ( {α}_{0 , i} - {α}_{0 , i + 1} ) \frac{1 - {e}^{- α L}}{α} \\ = ln {P}_{i} ( 0 ) - ln {P}_{i + 1} ( 0 ) - \frac{k}{2} ( {f}_{i} - {f}_{i + 1} ) {\sum }_{j = 1}^{M} {P}_{j} ( 0 ) \frac{1 - {e}^{- α L}}{α}\end{matrix} & Equation ( 5 c )\end{matrix}$$

$$ln \frac{{P}_{i + 1} ( 0 )}{{P}_{i} ( 0 )} = - \frac{kf}{2} {\sum }_{j = 1}^{M} {P}_{j} ( 0 ) \frac{1 - {e}^{- α L}}{α} \qquad Equation ( 5 d )$$

Equation (1) is derived by solving Equation (5b) as a geometric progression. When Equation (5d) is solved as a geometric progression, Equation (1B) is derived.

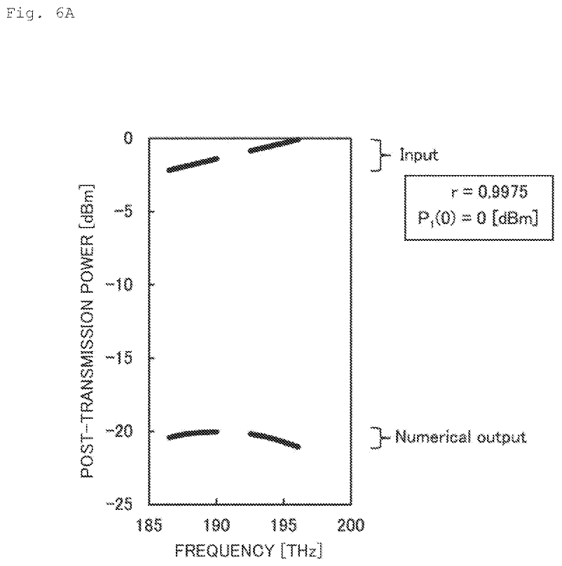

The calculation apparatus 30 according to the first embodiment calculates the input power of each channel on the basis of Equation (1B) obtained by setting ρ₁=ρ₂=1 in Equation (1). An example of P1(0) expressed as a function of r assuming that i is 1 in Equation (1B) by the calculation apparatus 30 is illustrated in FIG. 5. The calculation apparatus 30 may adjust r in consideration of a generalized signal-to-noise ratio (GSNR) from a relationship (r, P₁ [dBm]).

According to the graph of FIG. 5, it can be seen that, for example, when P₁ [dBm]=0 [dBm], r=0.9975. When P₁ [dBm]=3 [dBm], r=0.9955. When P₁ [dBm]=5 [dBm], r=0.9937. The calculation apparatus 30 can obtain, through calculation, r corresponding to a set value stored in advance as P₁ [dBm] from a relational equation (r, P₁ [dBm]) on the basis of the set value, for example. Further, the calculation apparatus 30 may obtain, through calculation, r corresponding to the input value from a relational equation (r, P₁ [dBm]) on the basis of the input value input by the user as P₁ [dBm], for example.

Next, a first simulation performed to confirm effects of the calculation apparatus 30 according to the present embodiment will be described.

### Example 1

The calculation apparatus 30 calculated the input powers of L 72 ch and C 72 ch on condition of r=0.9975 (corresponding to P₁(0)=0 dBm) in Equation (1B). To be specific, M=144, a frequency fᵢ is set as L 72 ch from 186.5 [THz] to 190.05 [THz] at a center frequency interval f=50 [GHz], and is set as C 72 ch from a frequency 192.55 [THz] to 196.1 [THz] at a center frequency interval f=50 [GHz]. The loss coefficient α was assumed to be αᵢ illustrated in FIG. 4A. A slope k of the Raman gain coefficient was assumed to be a slope of the graph illustrated in FIG. 4D. A span length L was assumed to be 100 [km].

Further, in Example 1, for confirmation of the effects of the calculation apparatus 30, the power before transmission was set to P₁(0)=0 dBm, and the power for each channel after 100 km transmission (post-transmission spectrum) was obtained through numerical calculation on the basis of Equation (2).

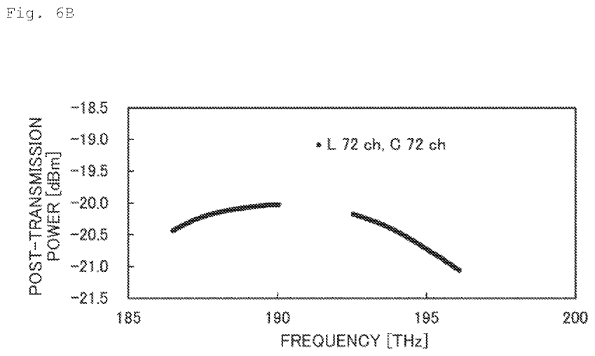

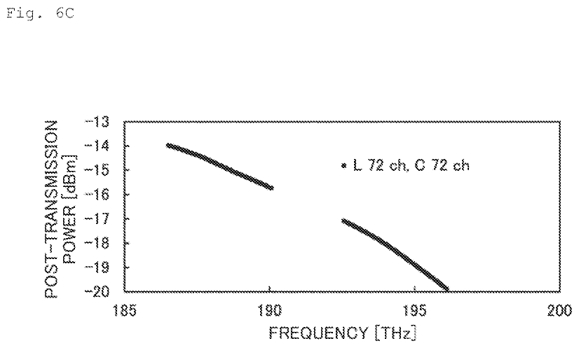

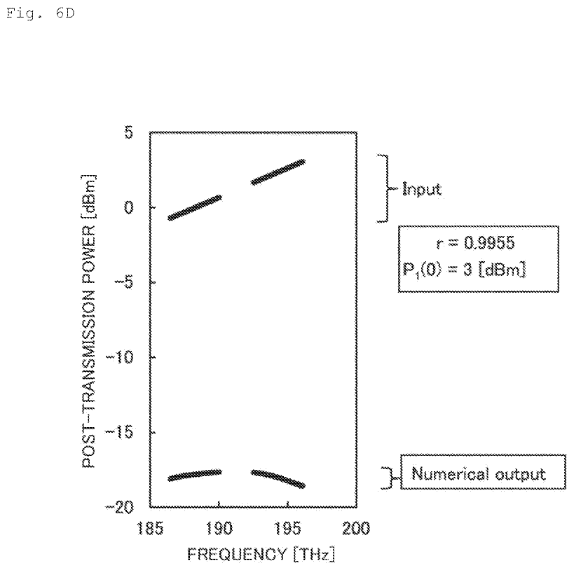

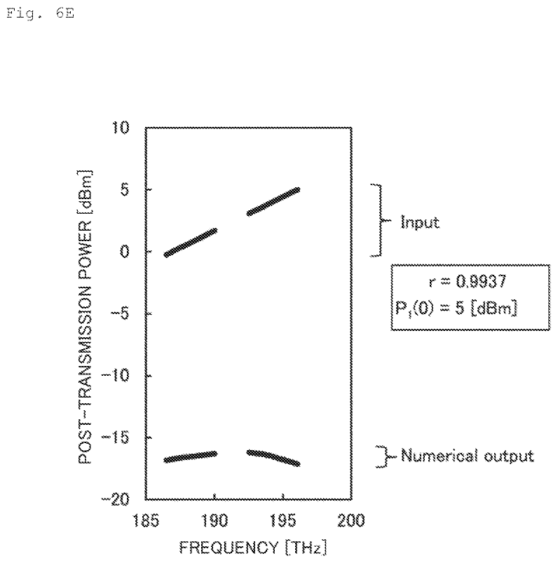

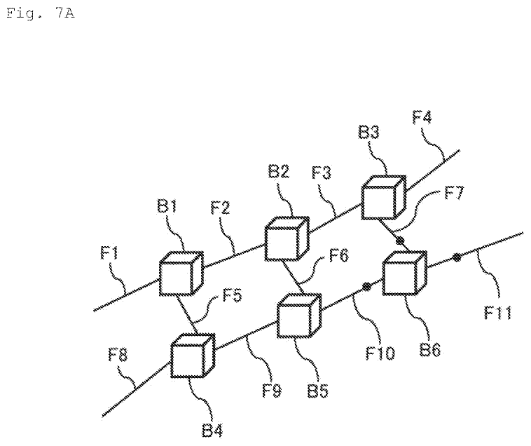

FIG. 6A is a graph showing Example 1 of an input power spectrum and a post-transmission power spectrum. In FIG. 6A, a horizontal axis indicates a frequency, and a vertical axis indicates post-transmission power and input power. In the figure, Input indicates the input power. Numerical output is a result of numerical calculation of the post-transmission spectrum based on Equation (2).

In the channel 144, the input power was −2.175 dBm and the post-transmission power was-20.412 dBm, with a loss of about 18 dBm.

In the channel 1, the input power was 0 dBm, and the post-transmission power was-20.060 dBm, with a loss of about 20 dBm.

As illustrated in the figure, the post-transmission power spectrum became flat.

FIG. 6B is a graph showing an enlarged view of the post-transmission power spectrum of FIG. 6A.

FIG. 6C is a graph showing the post-transmission power spectrum of a comparative example in which nothing is made to the input power. For the comparative example, the slope of the span incoming power is obvious, and a difference between a maximum value and a minimum value of the post-transmission power is about 6 dB.

On the other hand, the calculation apparatus 30 can calculate the input power that makes the range of the span incoming power generated due to stimulated Raman scattering less than or equal to 1 dB. In Example 1, as illustrated in FIG. 6B, a slope of the span incoming power caused due to stimulated Raman scattering is eliminated and becomes flat. Example 1 shows good results that can improve the variation in signal quality due to wavelength.

As illustrated in FIG. 6B, the difference between the maximum value and the minimum value of the post-transmission power is about 1 dB. This is caused by the transmission loss in addition to a physical phenomenon of stimulated Raman scattering. A wavelength dependence of the loss of the transmission path of the optical fiber itself can be expressed as 0.01 dB/km×L. When the span length L is 100 [km], the transmission loss is 1 dB.

The network apparatus 20 including the calculation apparatus 30 inputs light in two adjacent bands to the optical fiber transmission path with the calculated input power, and sets the range of the span incoming power to 0.01 dB/km×L+1 dB or less for both the channel center frequency and the number of existing channels in the optical fiber transmission path. Here, L is a span length [km] of the optical fiber transmission path.

### Example 2

The calculation apparatus 30 calculated the input powers of L 72 ch and C 72 ch on condition of r=0.9955 (corresponding to P₁(0)=3 dBm) in Equation (1B), similarly to Example 1. Further, in Example 2, for confirmation of the effects of the calculation apparatus 30, the power before transmission was set to P₁(0)=3 dBm, and the power for each channel after 100 km transmission (post-transmission spectrum) was obtained through numerical calculation on the basis of Equation (2). FIG. 6D is a graph showing Example 2 of the input power spectrum and the post-transmission power spectrum. Example 2 shows good results that can improve the variation in signal quality due to wavelength.

### Example 3

The calculation apparatus 30 calculated the input powers of L 72 ch and C 72 ch on condition of r=0.9937 (corresponding to P₁(0)=5 dBm) in Equation (1B), similarly to Example 1. Further, in Example 3, for confirmation of the effects of the calculation apparatus 30, the power before transmission was set to P₁(0)=5 dBm, and the power for each channel after 100 km transmission (post-transmission spectrum) was obtained through numerical calculation on the basis of Equation (2). FIG. 6E is a graph showing Example 3 of the input power spectrum and the post-transmission power spectrum. Example 3 shows good results that can improve the variation in signal quality due to wavelength.

### Second Embodiment

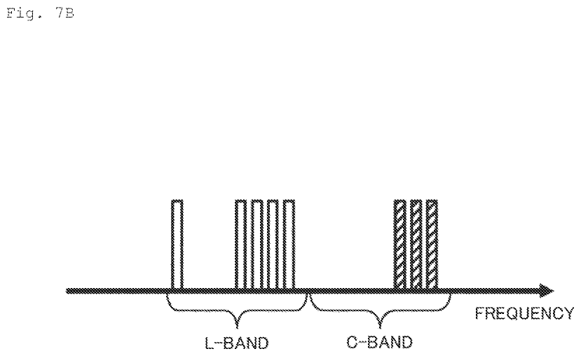

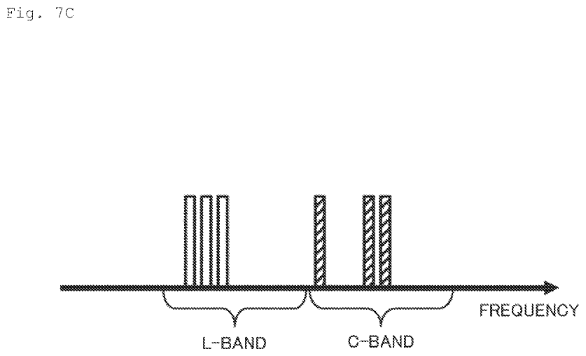

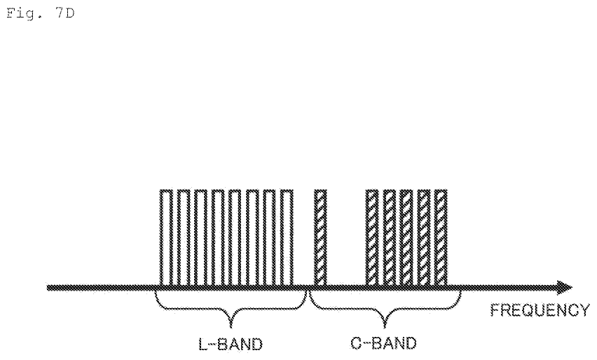

In the first embodiment, the input power was calculated with all wavelengths in each band. However, considering a wavelength usage situation of an actual wavelength multiplexing network, all available channels is less likely to be wavelength multiplexed. Further, in the actual wavelength multiplexing network, the number of wavelengths to be multiplexed changes over time, and optimal conditions for transmission change from moment to moment. In the present embodiment as well, for example, as illustrated in FIG. 7A, the network apparatus 20 including the calculation apparatus 30 is disposed in each of the buildings B1 to B6. For example, an optical signal passing through the optical fiber transmission path F7 and an optical signal passing through the optical fiber transmission path F10 are combined at the network apparatus 20 disposed in the building B6, and pass through the optical fiber transmission path F11. FIG. 7B illustrates a power spectrum of the optical signal passing through the optical fiber transmission path F7. FIG. 7C illustrates a power spectrum of the optical signal passing through the optical fiber transmission path F10. FIG. 7D illustrates a power spectrum of the optical signal passing through the optical fiber transmission path F11. Thus, in the actual wavelength multiplexing network, each wavelength repeats merging and branching. Therefore, in the second embodiment, the channel occupancy rates ρ_{C} and ρ_{L} are taken into consideration.

According to the consideration of the power transition between channels (wavelengths) due to stimulated Raman scattering, four sets below have the same number of wavelengths and have a maximum difference due to the wavelength disposition of two adjacent bands.

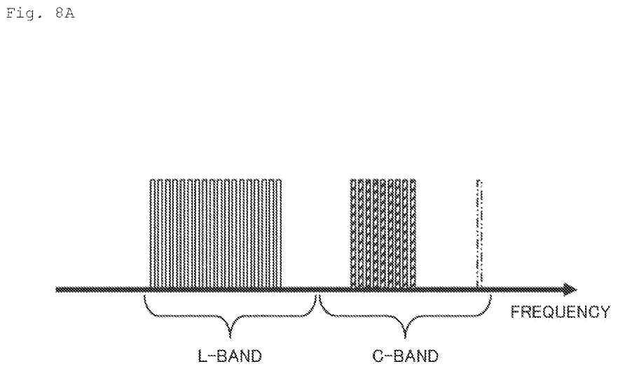

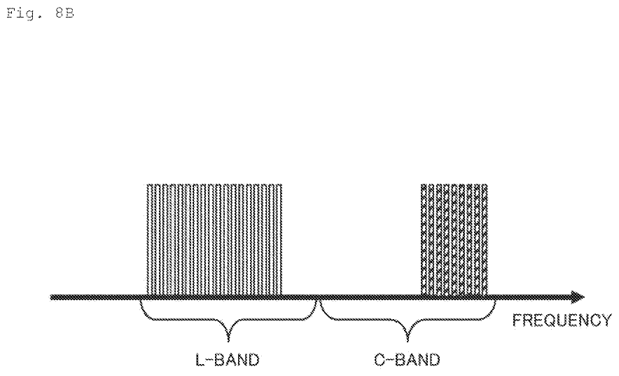

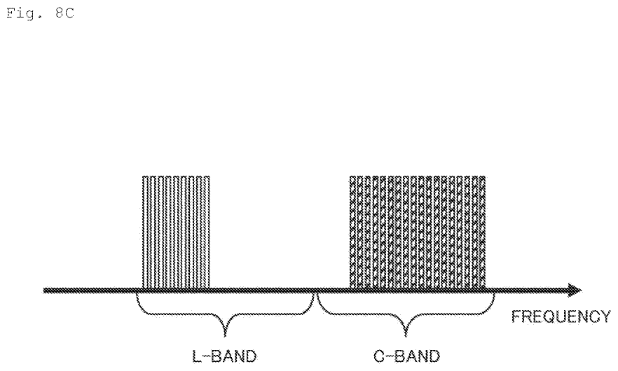

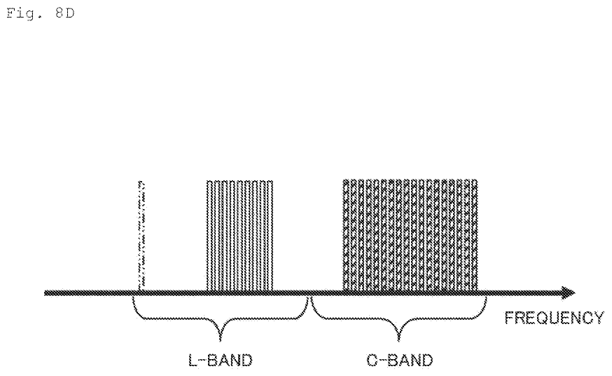

A first set is a set consisting of all L band channels and half of the C band channels (lowest frequency side), as illustrated in FIG. 8A.

A second set is a set consisting of all L band channels and half of the C band channels (highest frequency side), as illustrated in FIG. 8B.

A third set is a set consisting of half of the L band channels (lowest frequency side) and all of the C band channels, as illustrated in FIG. 8C.

A fourth set is a set consisting of half of the L band channels (highest frequency side) and all of the C band channels, as illustrated in FIG. 8D.

A difference between the four sets of dispositions is as small as 0.5 [dB]. That is, the power transition does not depend on the wavelength disposition of each band, but is determined by the number of wavelengths. This number of wavelengths is expressed as a sum of a product of a total number M of channels and a channel occupancy rate ρ_{C} and a product of the total number M of channels and a channel occupancy rate ρ_{L}.

The calculation apparatus 30 according to the second embodiment determines the coefficient r when a desired communication possibility P₁(0) is applied in a case in which i is 1 in Equation (1), and fixes the determined coefficient r to execute the calculation of the input power of each channel on the basis of Equation (1). Specifically, the calculation apparatus 30 first expresses P₁(0) as a function of r assuming that i is 1 in Equation (1), as illustrated in FIG. 3B (step S21). In this case, Equation (1) can be rewritten as Equation (1D) below.

$$\begin{matrix}[ Math . 8 ] & \\ {P}_{1} ( 0 ) = \frac{2 α ( r - 1 ) ln r}{kf ( 1 - {e}^{- α L} ) ( {ρ}_{C} + {ρ}_{L} {r}^{\frac{M}{2}} ) ( 1 - {r}^{\frac{M}{2}} )} & Equation ( 1 D )\end{matrix}$$

The calculation apparatus 30 determines the coefficient r when the desired P₁(0) is applied in a relational equation (Equation (1D)) between P₁(0) and r (step S22). The calculation apparatus 30 fixes the coefficient r to calculate the input power on the basis of Equation (1) (step S23).

The calculation apparatus 30 according to the second embodiment calculates the input power of each channel on the basis of Equation (1). For simplicity, it is assumed that a graph in FIG. 5 is P₁(0) expressed as a function of r, assuming that i is 1 in Equation (1). The calculation apparatus 30 may adjust r in consideration of GSNR from a relationship (r, ρ_{C}, ρ_{L}, P₁ [dBm]).

Next, a second simulation performed to confirm the effects of the calculation apparatus 30 according to the present embodiment will be described.

In the graph of FIG. 5, for example, r=0.9975, 0.9981, 0.9980, 0.9986 are all assumed to be P₁ [dBm]=0 [dBm], and the calculation was made for four patterns in which the channel occupancy rates ρ_{C} and ρ_{L} were 0.5 or 1.0 (hereinafter referred to as Example 4, Example 5, Example 6, and Example 7),

Further, in the second simulation, in order to confirm the effects of the calculation apparatus 30, the power before transmission is set to P₁(0)=0 dBm, and the power for each channel after 100 km transmission (post-transmission spectrum) was obtained through numerical calculation on the basis of Equation (2).

### Example 4

The calculation apparatus 30 calculated the input powers of L 72 ch and C 72 ch on condition of (r, ρ_{C}, ρ_{L}, P₁ [dBm])=(0.9975, 1.0, 1.0, 0) in Equation (1). Detailed conditions are the same as in Example 1.

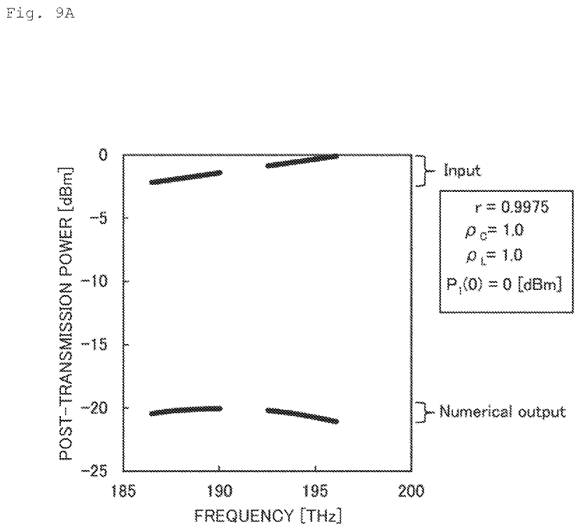

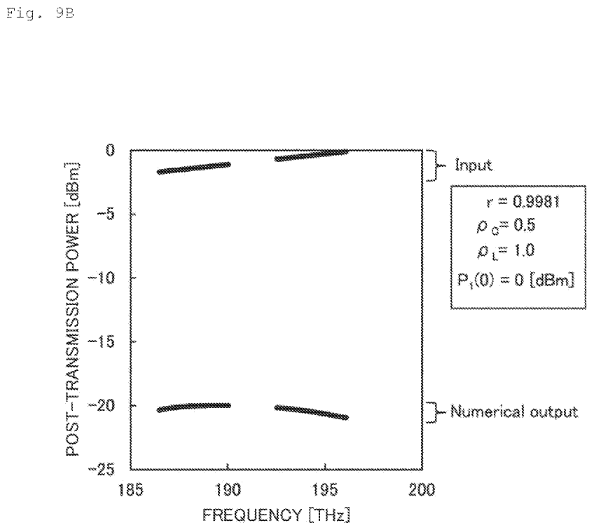

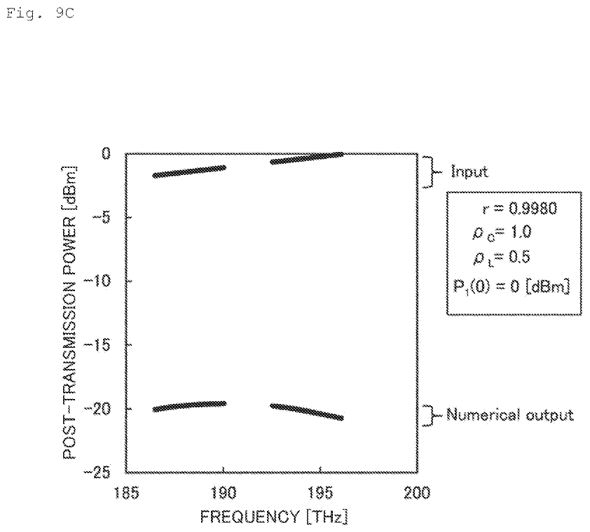

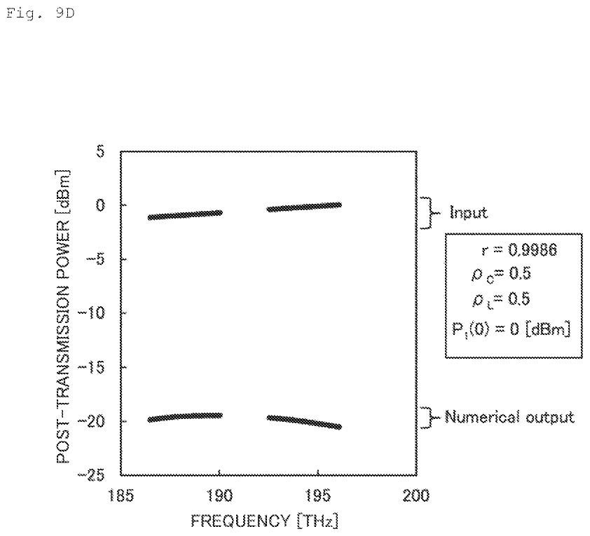

FIG. 9A is a graph showing Example 4 of the input power spectrum and the post-transmission power spectrum. The graph can be viewed in the same way as the graph in FIG. 6A. As illustrated in the figure, the post-transmission power spectrum became flat.

### Example 5

The calculation apparatus 30 calculated the input powers of L 72 ch and C 72 ch on condition of (r, ρ_{C}, ρ_{L}, P₁ [dBm])=(0.9980, 1.0, 0.5, 0) in Equation (1). Detailed conditions are the same as in Example 1.

FIG. 9B is a graph showing Example 5 of the input power spectrum and the post-transmission power spectrum. The graph can be viewed in the same way as the graph in FIG. 6A. As illustrated in the figure, the post-transmission power spectrum became flat.

### Example 6

The calculation apparatus 30 calculated the input powers of L 72 ch and C 72 ch on condition of (r, ρ_{C}, ρ_{L}, P₁ [dBm])=(0.9981, 0.5, 1.0, 0) in Equation (1). Detailed conditions are the same as in Example 1.

FIG. 9C is a graph showing Example 6 of the input power spectrum and the post-transmission power spectrum. The graph can be viewed in the same way as the graph in FIG. 6A. As illustrated in the figure, the post-transmission power spectrum became flat.

### Example 7

The calculation apparatus 30 calculated the input power of L 72 ch and C 72 ch on condition of (r, ρ_{C}, ρ_{L}, P₁ [dBm])=(0.9986, 0.5, 0.5, 0) in Equation (1). Detailed conditions are the same as in Example 1.

FIG. 9D is a graph showing Example 7 of the input power spectrum and the post-transmission power spectrum. The graph can be viewed in the same way as the graph in FIG. 6A. As illustrated in the figure, the post-transmission power spectrum became flat.

Next, a third simulation performed to confirm the effects of the calculation apparatus 30 according to the present embodiment will be described.

In the graph of FIG. 5, for example, the input power was calculated on the basis of Equation (1) on the same conditions as in Example 1, for 12 patterns (hereinafter referred to as Examples 8 to 19) of various channel occupancy rates ρ_{C} and ρ_{L} on condition of r=0.9975 (corresponding to Pᵢ(0)=0 dBm). Further, in the third simulation, in order to confirm the effects of the calculation apparatus 30, the power before transmission is set to Pᵢ(0)=0 dBm, and the power for each channel after 100 km transmission (post-transmission spectrum) was obtained through numerical calculation on the basis of Equation (2).

### Example 8

The calculation apparatus 30 calculated the input powers of L 72 ch and C 36 ch (lower) in Equation (1). Here, C 36 ch (lower) means ch37 to ch72.

### Example 9

The calculation apparatus 30 calculated the input powers of L 72 ch and C 36 ch (higher) in Equation (1). Here, C 36 ch (higher) means ch1 to ch36.

### Example 10

The calculation apparatus 30 calculated the input powers of L 72 ch and C 36 ch (alternate) in Equation (1). Here, C 36 ch (alternate) means an odd channel (1, 3, . . . , 71) of C band.

### Example 11

The calculation apparatus 30 calculated the input powers of L 36 ch (lower) and C 72 ch in Equation (1). Here, L 36 ch (lower) means ch109 to ch144.

### Example 12

The calculation apparatus 30 calculated the input powers of L 36 ch (higher) and C 72 ch in Equation (1). Here, L 36 ch (higher) means ch73 to ch108.

### Example 13

The calculation apparatus 30 calculated the input powers of L 36 ch (alternate) and C 72 ch in Equation (1). Here, L 36 ch (alternate) means an odd channel (73, 75, . . . , 143) in the L band.

### Example 14

The calculation apparatus 30 calculated the input powers of L 72 ch and C 1 ch (lowest) in Equation (1). Here, C 1 ch (lowest) means ch72.

### Example 15

The calculation apparatus 30 calculated the input powers of L 72 ch and C 1 ch (highest) in Equation (1). Here, C 1 ch (highest) means ch1.

### Example 16

The calculation apparatus 30 calculated the input powers of L 72 ch and C 1 ch (middle) in Equation (1). Here, C 1 ch (middle) means ch36.

### Example 17

The calculation apparatus 30 calculated the input powers of L 1 ch (lowest) and C 72 ch in Equation (1). Here, L 1 ch (lowest) means ch144.

### Example 18

The calculation apparatus 30 calculated the input powers of L 1 ch (highest) and C 72 ch in Equation (1). Here, L 1 ch (highest) means ch73.

### Example 19

The calculation apparatus 30 calculated input powers of L 1 ch (middle) and C 72 ch in Equation (1). Here, L 1 ch (middle) means ch108.

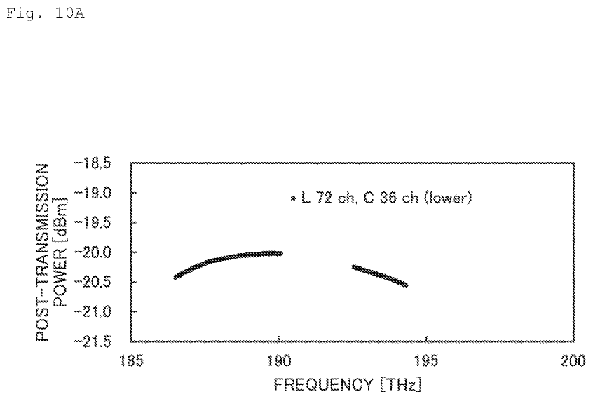

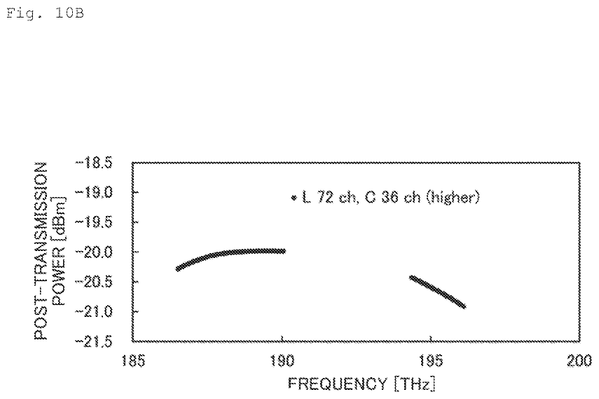

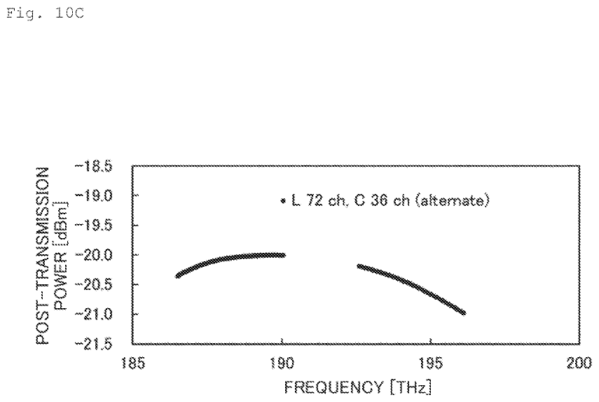

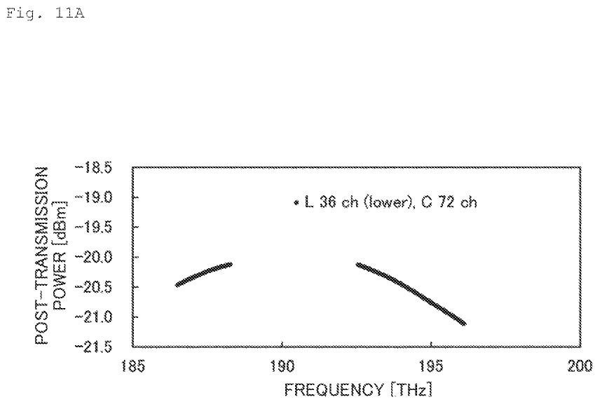

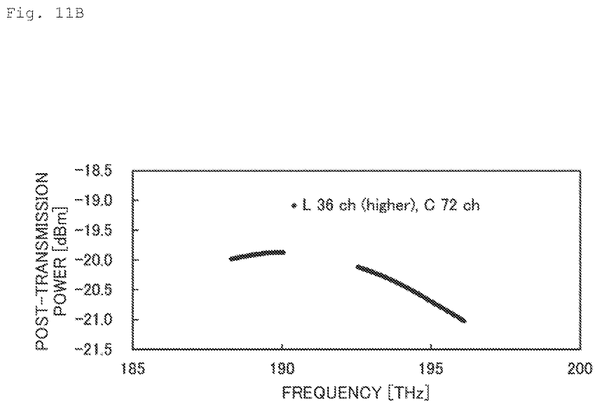

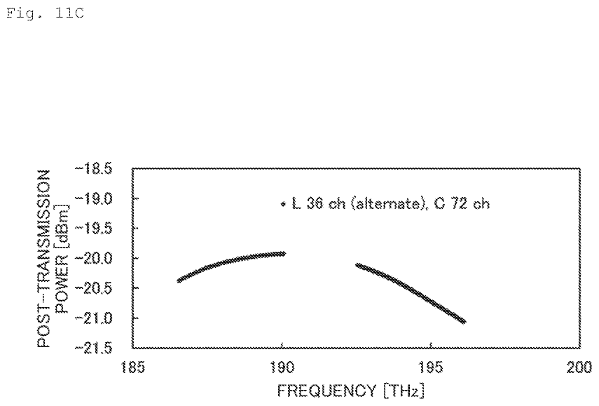

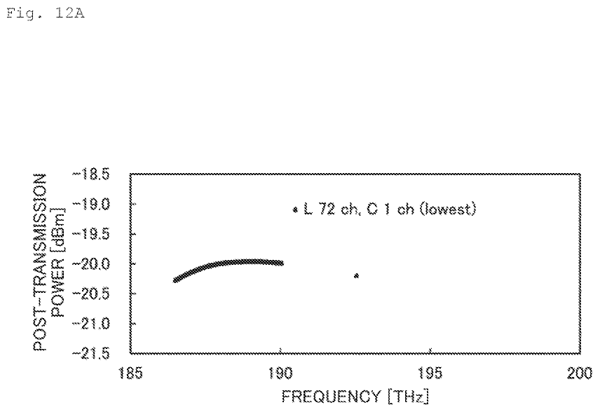

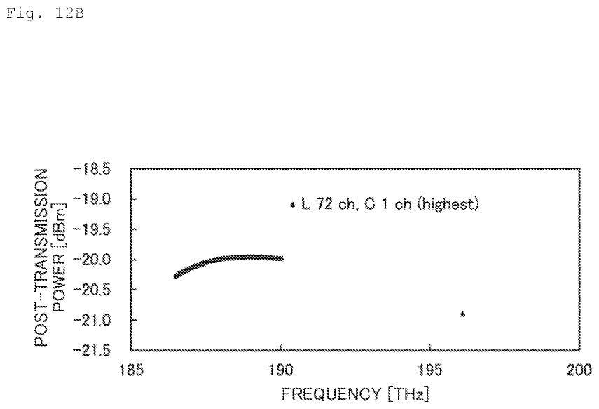

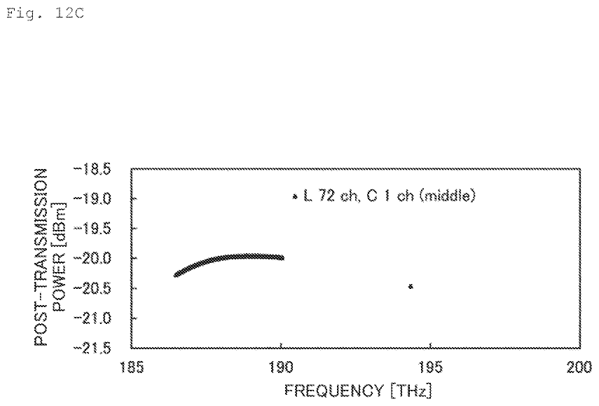

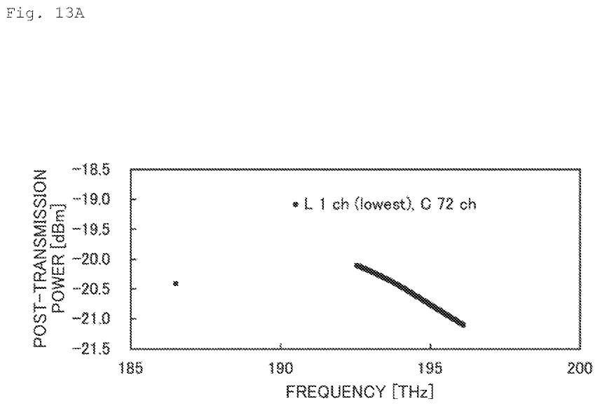

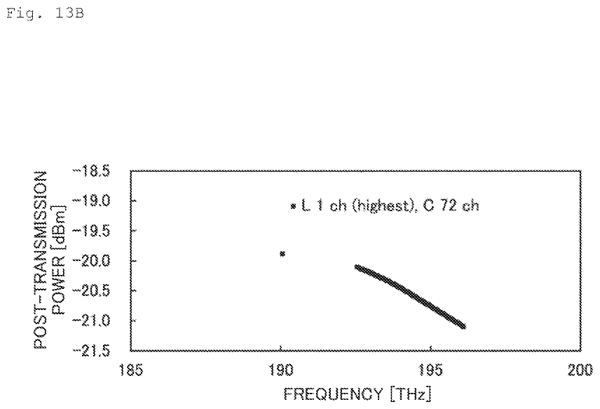

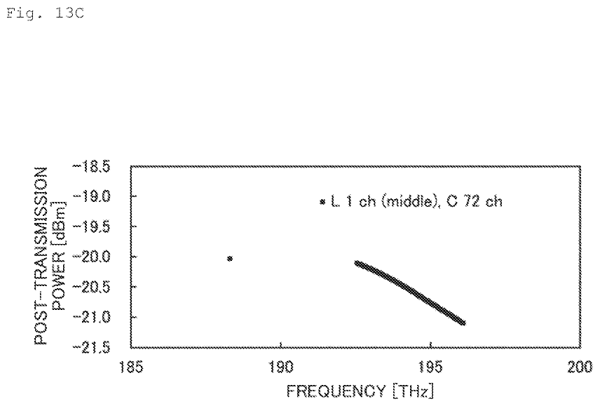

FIG. 10A, FIG. 10B, FIG. 10C, FIG. 11A, FIG. 11B, FIG. 11C, FIG. 12A, FIG. 12B, FIG. 12C, FIG. 13A, FIG. 13B, and FIG. 13C show numerical calculation results of the post-transmission power spectra for Examples 8 to 19, respectively.

The calculation apparatus 30 of the second embodiment can calculate the input power that makes the range of the span incoming power generated due to the stimulated Raman scattering less than or equal to 1 dB. Examples 4 to 19 show good results that can improve the variation in signal quality due to wavelength.

### [Hardware Configuration]

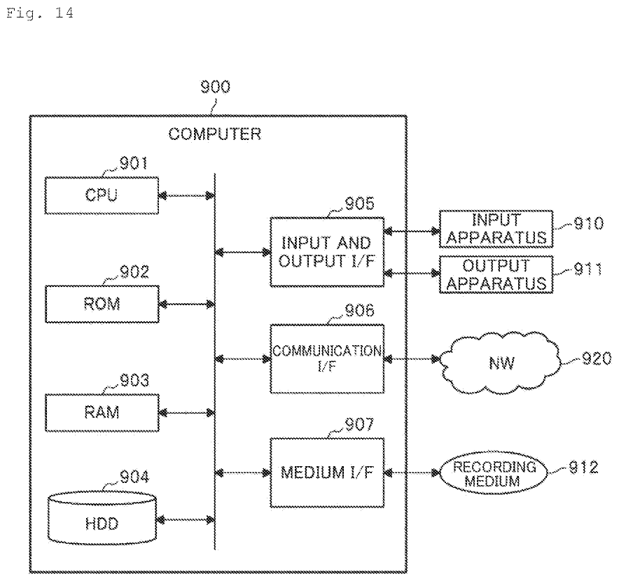

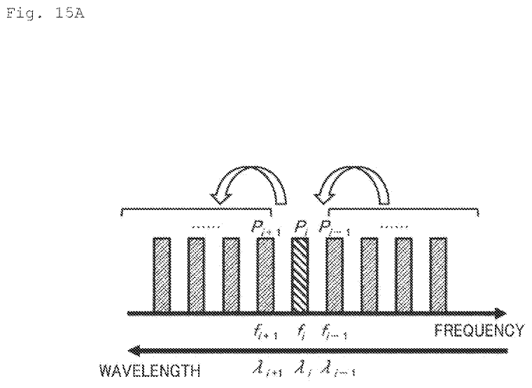

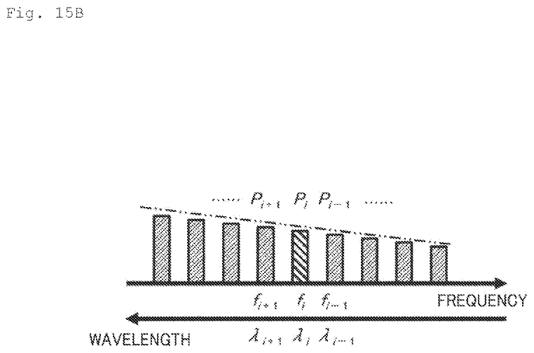

The calculation apparatus 30 according to the embodiment is realized, for example, by a computer 900 configured as illustrated in FIG. 14. FIG. 14 is a hardware configuration diagram illustrating an example of the computer 900 that realizes functions of the calculation apparatus 30 according to the present embodiment. The computer 900 includes a central processing unit (CPU) 901, a read only memory (ROM) 902, a random access memory (RAM) 903, a hard disk drive (HDD) 904, an input/output interface (I/F) 905, a communication I/F 906, and a media I/F 907.

The CPU 901 operates on the basis of a program stored in the ROM 902 or the HDD 904. The ROM 902 stores a boot program executed by the CPU 901 when the computer 900 is started, a program related to hardware of the computer 900, and the like.

The CPU 901 controls an input apparatus 910 such as a mouse or a keyboard, and an output apparatus 911 such as a display or a printer through the input and output I/F 905. The CPU 901 acquires data from the input apparatus 910 through the input and output I/F 905, and outputs generated data to the output apparatus 911. A graphics processing unit (GPU) or the like may be used in addition to the CPU 901 as the processor.

The HDD 904 stores a program executed by the CPU 901, data used by the program, and the like. The communication I/F 906 receives data from other devices via a communication network 920, outputs the data to the CPU 901, and also transmits data generated by the CPU 901 to other devices via the communication network 920.

The media I/F 907 reads the program or data stored in the recording medium 912 and outputs the program or data to the CPU 901 via the RAM 903. The CPU 901 loads a program related to target processing from the recording medium 912 onto the RAM 903 via the media I/F 907, and executes the loaded program. The recording medium 912 is an optical recording medium such as a digital versatile disc (DVD) or a phase change rewritable disk (PD), a magneto-optical recording medium such as a magneto optical disk (MO), a magnetic recording medium, a semiconductor memory, or the like.

For example, when the computer 900 functions as the calculation apparatus 30 according to the embodiment, the CPU 901 realizes the functions of the calculation apparatus 30 by executing a program loaded onto the RAM 903. Further, data in the RAM 903 is stored in the HDD 904. The CPU 901 reads the program related to the desired processing from the recording medium 912 and executes the program. In addition, the CPU 901 may read a program related to target processing from another device via the communication network 920.

### Effects

As described above, the calculation apparatus is a calculation apparatus for calculating an input power to an optical fiber transmission path of each channel in two adjacent bands, wherein the calculation apparatus assumes that a transition of a span incoming power due to an influence of stimulated Raman scattering depends on the number of existing channels in an optical fiber transmission path, and calculates an input power for eliminating a slope of the span incoming power using a coefficient r indicating a power ratio of a target channel and an adjacent channel.

By doing so, the calculation apparatus calculates the input power of each channel in the two adjacent bands. Therefore, the calculation apparatus can calculate whether an amount of pre-increase in the input power in the short wavelength band is optimal, in order to keep the incoming power constant from the short wavelength band to the long wavelength band on the receiving side.

The calculation apparatus is characterized by executing calculation of the input power of each channel on the basis of Equation (1) below when i is the number indicating the channel (1≤i≤M), fᵢ is the center frequency of channel i (f_{M}≤fᵢ≤f₁, and 4 THz≤f₁−f_{M}≤15 THz)), f is the center frequency interval of adjacent channels, Pᵢ(0) is the input power to the optical fiber transmission path of channel I (0.1 mW≤Pᵢ(0)≤10 mW), r is a coefficient indicating the power ratio between the target channel and the adjacent channel, ρ₁ is the channel occupancy rate of the high frequency short wavelength side band 1, ρ₂ is the channel occupancy rate of the low frequency long wavelength band 2, L is the span length of the optical fiber transmission path, a is the loss coefficient of the optical fiber transmission path, and k is the slope of the Raman gain coefficient.

$$\begin{matrix}[ Math . 9 ] & \\ {P}_{1} ( 0 ) = \frac{2 α ( r - 1 ) ln r}{kf ( 1 - {e}^{- α L} ) ( {ρ}_{1} + {ρ}_{2} {r}^{\frac{M}{2}} ) ( 1 - {r}^{\frac{M}{2}} )} {r}^{\frac{{f}_{1} - {f}_{l}}{f}} & Equation ( 1 )\end{matrix}$$

By doing so, the calculation apparatus calculates the input power of each channel in the two adjacent bands on the basis of Equation (1). Equation (1) is an equation created by focusing on change in the wavelength of the adjacent channel, assuming that the transition of the span incoming power due to the influence of stimulated Raman scattering does not depend on the wavelength disposition of each band, but depends on the number of existing channels in the optical fiber transmission path. The coefficient r corresponds to a common ratio of the geometric progression. The calculation apparatus can calculate the input power for eliminating the slope of the span incoming power in the DWDM by using an appropriate coefficient r in Equation (1).

The calculation apparatus determines the coefficient r when a desired communication possibility P₁(0) is applied in a case in which i is 1 in Equation (1), and fixes the determined coefficient r to execute the calculation of the input power of each channel on the basis of Equation (1).

By doing this, the calculation apparatus determines the coefficient r when desired P₁(0) is applied to a relational equation between r and P₁(0) when r on the right side of Equation (1) is changed, when the left side of Equation (1) is P₁(0). This coefficient r is smaller than 1. Using Equation (1), the calculation apparatus can calculate an input power spectrum having a slope such that the power of the channel is smaller when the number indicating the channel is larger. Therefore, according to the calculated input power, it is possible to flatten the span incoming power having such a slope that the incoming power of the channel increases when the number indicating the channel becomes larger. Further, even when the input power at the highest frequency (P₁(0) [dBm]) at an input end of each band is changed, the calculation apparatus can easily obtain an optimal value of the input power of each channel using Equation (1) if determining the coefficient r each time.

The calculation apparatus is characterized by determining the coefficient r and fixing the determined coefficient r when ρ₁=ρ₂=1 in Equation (1), and executing calculation of the input power of each channel on the basis of Equation (1) below when ρ₁=ρ₂=1 in Equation (1).

By doing so, the calculation apparatus determines the coefficient r by assuming that the channel occupancy rate of the high frequency short wavelength side band 1 and the channel occupancy rate of the low frequency long wavelength side band 2 are 1. Therefore, the calculation apparatus can calculate the input power in a state in which all the channels are present (a state in which all the channels are filled) in the two adjacent bands.

The network apparatus is characterized by including the calculation apparatus, and setting the span incoming power range to 0.01 dB/km×L+1 dB or less for both the channel center frequency and the number of existing channels in the optical fiber transmission path when the light in two adjacent bands is input to the optical fiber transmission path with the input power calculated by the calculation apparatus and the span length of the optical fiber transmission path is set to L km.

By doing so, in the network apparatus, the calculation apparatus calculates the input power that makes the range of the span incoming power generated less than or equal to 1 dB, for elimination of the slope of the span incoming power caused by the physical phenomenon of stimulated Raman scattering. Further, the wavelength dependence of the loss of the transmission path of the optical fiber itself can be expressed as 0.01 dB/km×L, in addition to stimulated Raman scattering. When the network apparatus inputs the light in the two adjacent bands to the optical fiber transmission path with the calculated input power, the network apparatus flattens the span incoming power on condition also including the wavelength dependence of the loss of the transmission line of the optical fiber itself, to improve the variation in signal quality due to wavelength.

A calculation method is a calculation method for a calculation apparatus for calculating an input power to an optical fiber transmission path of each channel in two adjacent bands, and assumes that a transition of a span incoming power due to an influence of stimulated Raman scattering depends on the number of existing channels in an optical fiber transmission path, and calculates an input power for eliminating a slope of the span incoming power using a coefficient r indicating a power ratio of a target channel and an adjacent channel.

By doing so, the calculation apparatus 30 calculates the input power of each channel in the two adjacent bands. Therefore, the calculation apparatus 30 can calculate whether an amount of pre-increase in the input power in the short wavelength band is optimal, in order to keep the incoming power constant from the short wavelength band to the long wavelength band on the receiving side.

The calculation method is characterized by executing calculation of the input power of each channel on the basis of Equation (1) below when i is the number indicating the channel (1≤i≤M), fᵢ is the center frequency of channel i (f_{M}≤fᵢ≤f₁, and 4 THz≤f₁−f_{M}≤15 THz), f is the center frequency interval of adjacent channels, Pᵢ(0) is the input power to the optical fiber transmission path of channel I (0.1 mW≤Pᵢ(0)=10 mW), r is a coefficient indicating the power ratio between the target channel and the adjacent channel, ρ₁ is the channel occupancy rate of the high frequency short wavelength side band 1, ρ₂ is the channel occupancy rate of the low frequency long wavelength band 2, L is the span length of the optical fiber transmission path, a is the loss coefficient of the optical fiber transmission path, and k is the slope of the Raman gain coefficient.

$$\begin{matrix}[ Math . 10 ] & \\ {P}_{i} ( 0 ) = \frac{2 α ( r - 1 ) ln r}{kf ( 1 - {e}^{- α L} ) ( {ρ}_{1} + {ρ}_{2} {r}^{\frac{M}{2}} ) ( 1 - {r}^{\frac{M}{2}} )} {r}^{\frac{{f}_{1} - {f}_{l}}{f}} & Equation ( 1 )\end{matrix}$$

By doing so, in the calculation method, the calculation apparatus 30 calculates the input power of each channel in the two adjacent bands on the basis of Equation (1). Equation (1) is an equation created by focusing on change in the wavelength of the adjacent channel, assuming that the transition of the span incoming power due to the influence of stimulated Raman scattering does not depend on the wavelength disposition of each band, but depends on the number of existing channels in the optical fiber transmission path. The coefficient r corresponds to a common ratio of the geometric progression. The calculation apparatus 30 can calculate the input power for eliminating the slope of the span incoming power in the DWDM by using an appropriate coefficient r in Equation (1).

The present invention is not limited to the embodiments described above, and many modifications can be made within the technical idea of the present invention by those having ordinary knowledge in this field.

For example, although the two adjacent bands are the L band and the C band, the bands may be the C band and the S band, or may be a Ultralong wavelength (U band) and the L band.

Further, the control units 24 of the network apparatuses NE1 and NE2 include the calculation apparatus 30, but the present invention is not limited thereto. For example, the control unit 24 of the network apparatus NE3 may include the calculation apparatus 30. Further, the control unit 11 of the network equipment monitoring apparatus 10 may include the calculation apparatus 30.

### REFERENCE SIGNS LIST

1 Optical transmission system
10 Network equipment monitoring apparatus
11 Control unit
20 Network apparatus
21 Transponder
22 Wavelength selective switch
23 Optical amplification unit
24 Control unit
30 Calculation apparatus

1. A calculation apparatus including one or more processors configured to calculate an input power to an optical fiber transmission path of each channel in two adjacent bands, wherein the calculation apparatus is configured to assume that a transition of span incoming power due to an influence of stimulated Raman scattering depends on the number of existing channels in an optical fiber transmission path, and calculate input power for eliminating a slope of the span incoming power using a coefficient r indicating a power ratio of a target channel and an adjacent channel.

2. The calculation apparatus according to claim 1, wherein the calculation apparatus is further configured to execute calculation of the input power of each channel on the basis of Equation (1) below when i is a number indicating the channel (1≤i≤M), fᵢ is a center frequency of channel i (f_{M}≤fᵢ≤f₁, and 4 THz≤f₁−f_{M}≤15 THz), f is a center frequency interval of adjacent channels, Pi(0) is an input power to an optical fiber transmission path of channel i (0.1 mW≤Pᵢ(0)≤10 mW), r is a coefficient indicating a power ratio between the target channel and the adjacent channel, ρ₁ is a channel occupancy rate of a high frequency short wavelength side band 1, ρ₂ is a channel occupancy rate of a low frequency long wavelength band 2, L is a span length of the optical fiber transmission path, a is a loss coefficient of the optical fiber transmission path, and k is a slope of a Raman gain coefficient;
wherein equation 1 comprises:
$${P}_{i} ( 0 ) = \frac{2 α ( r - 1 ) ln r}{kf ( 1 - {e}^{- α L} ) ( {ρ}_{1} + {ρ}_{2} {r}^{\frac{M}{2}} ) ( 1 - {r}^{\frac{M}{2}} )} {r}^{\frac{{f}_{1} - {f}_{l}}{f}} .$$

3. The calculation apparatus according to claim 2, wherein the calculation apparatus is further configured to determine the coefficient r when a desired communication possibility P₁(0) is applied in a case in which i is 1 in Equation (1), and fix the determined coefficient r to execute the calculation of the input power of each channel on the basis of Equation (1).

4. The calculation apparatus according to claim 3, wherein the calculation apparatus is further configured to:
determine the coefficient r when ρ₁=ρ₂=1 in Equation (1); and
execute the calculation of the input power of each channel on the basis of Equation (1) when the determined coefficient r is fixed and ρ₁=ρ₂=1 in Equation (1).

5. A network apparatus including one or more processors, wherein the network apparatus comprises:
a calculation apparatus including one or more processors configured to:
calculate an input power to an optical fiber transmission path of each channel in two adjacent bands;
assume that a transition of span incoming power due to an influence of stimulated Raman scattering depends on the number of existing channels in an optical fiber transmission path; and
calculate input power for eliminating a slope of the span incoming power using a coefficient r indicating a power ratio of a target channel and an adjacent channel, and wherein, when light in two adjacent bands is input to the optical fiber transmission path with the input power calculated by the calculation apparatus, and a span length of the optical fiber transmission path is set to L km,
a range of the span incoming power is set to 0.01 dB/km×L+1 dB or less for both the channel center frequency and the number of existing channels in the optical fiber transmission path.

6. A calculation method, performed by a calculation apparatus including one or more processors, for calculating input power to an optical fiber transmission path of each channel in two adjacent bands, the calculation method comprising:
assuming that a transition of span incoming power due to an influence of stimulated Raman scattering depends on the number of existing channels in an optical fiber transmission path; and
calculating input power for eliminating a slope of the span incoming power using a coefficient r indicating a power ratio of a target channel and an adjacent channel.

7. The calculation method according to claim 6, comprising: executing calculation of the input power of each channel on the basis of Equation (1) below when i is a number indicating the channel (1≤i≤M), fᵢ is a center frequency of channel i (f_{M}≤fᵢ≤f₁, and 4 THz≤fᵢ−f_{M}≤15 THz), f is a center frequency interval of adjacent channels, Pᵢ(0) is an input power to an optical fiber transmission path of channel i (0.1 mW≤Pᵢ(0)≤10 mW), r is a coefficient indicating a power ratio between the target channel and the adjacent channel, ρ₁ is a channel occupancy rate of a high frequency short wavelength side band 1, ρ₂ is a channel occupancy rate of a low frequency long wavelength band 2, L is a span length of the optical fiber transmission path, a is a loss coefficient of the optical fiber transmission path, and k is a slope of a Raman gain coefficient;
wherein equation 1 comprises:
$${P}_{i} ( 0 ) = \frac{2 α ( r - 1 ) ln r}{kf ( 1 - {e}^{- α L} ) ( {ρ}_{1} + {ρ}_{2} {r}^{\frac{M}{2}} ) ( 1 - {r}^{\frac{M}{2}} )} {r}^{\frac{{f}_{1} - {f}_{l}}{f}} .$$

8. (canceled)
